(19) United States
(12) Patent Application Publication
(10) Pub. No.: US 2009/0314426 A1
(43) Pub. Date: Dec. 24, 2009

(54) BOLTED JOINT

(76) Inventor: Uwe Steinke, Hamburg (DE)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/281,087

(22) PCT Filed: Mar. 16, 2007
(86) PCT No.: PCT/EP07/52526

§ 371 Date: Aug. 5, 2009

(30) Foreign Application Priority Data
Mar. 22, 2006 (DE) 10 2006 013 069.3

(51) Int. Cl. B29C 65/48

(52) U.S. Cl. 156/285

(57) ABSTRACT

The invention relates to a method for autoclave-free adhesive bonding of components in order to form in particular, large-sized structural components for aircraft. Since the curing of the least one adhesive film in order to connect the stringers takes place free of autoclaves in a vacuum bag at a relatively low partial vacuum between 70 kPa and 100 kPa, the previously necessary complex structure by masking sharp edges and/or arranging pressure elements on order to increase the local contact pressure in specific regions of the components is dispensed with.

The invention relates to a bolted joint for connecting load-transferring structural parts on an aircraft. Such joints are generally of double-shear configuration, a first structural part having a bolt eye being connected by means of a bolt to a second, generally fork-shaped structural part having two bolt eyes. In general, the direction of the loads transferred through the bolt from the structural parts runs at right angles to the bolt axis. Occasionally, for design reasons, bolted joints can also be realized in which the direction of the load arriving through the first structural part forms an angle ≠90° with the bolt axis. This means that on the side of the first structural part the bore for receiving the bolt should be made at an angle ≠90°, i.e. obliquely to the structural part or obliquely to the surface thereof. In order to achieve this, the surrounds of the bore are previously thickened and this local thickening relative to the rest of the structural part is provided with a bevel precisely corresponding to the necessary angle. As a result, the boring for making the receiving bore for the bolt can always be carried out locally perpendicular to the structural part surface, which is very desirable for methodological reasons. The said thickening is necessary because other measures, e.g. milling, for creating the local bevel would lead to a weakening of the structural part. Depending on the material of the structural parts, different bushing versions are used. If the structural parts consist of metal, then simple bushings of suitable material are forced in. If the structural parts consist of a fibre composite, however, then it is expedient to use so-called screw bushings. Owing to their shape, these allow the structural part material to be well supported in the axial direction.

In the case of structural parts corresponding to the aforementioned thickening, it is disadvantageous that the creation of the thickening involves a considerable amount of work, especially when the structural parts consist of fibre composite. In addition, it is disadvantageous that the thickening entails a longer bushing and hence also a longer bolt than in a structural part with no thickening. The longer bolt and the longer bushing give rise, in the first place, to a higher weight of the bolted joint. In the second place, in the case of a longer bolt, larger distances between the particular load-application points are obtained, whereby higher bending moments act upon the bolt than in a structural part with no thickening.

The object of the invention is therefore to refine a bolted joint according to the stated prior art in such a way that a thickening of the particular structural part, given an oblique position of the bolt axis relative to the structural part, is avoided.

This object is achieved according to claim 1 by the fact that the structural part has a constant thickness and the bushing is inserted perpendicular to the surface of the structural part, the axis of the bore within the bushing for receiving the bolt running obliquely to the surface of the structural part and obliquely to the end face of the bushing.

Advantageous embodiments of the invention are defined in the sub-claims.

By virtue of the invention:
the production-engineering input,
the length of the bushing,
the length of the bolt,
the weight of the bolted joint, and
the bending load upon the bolt are reduced. This yields advantages in terms of the costs and weight of the bolted joint.

The invention is represented in the drawing and explained in greater detail with reference to the description.

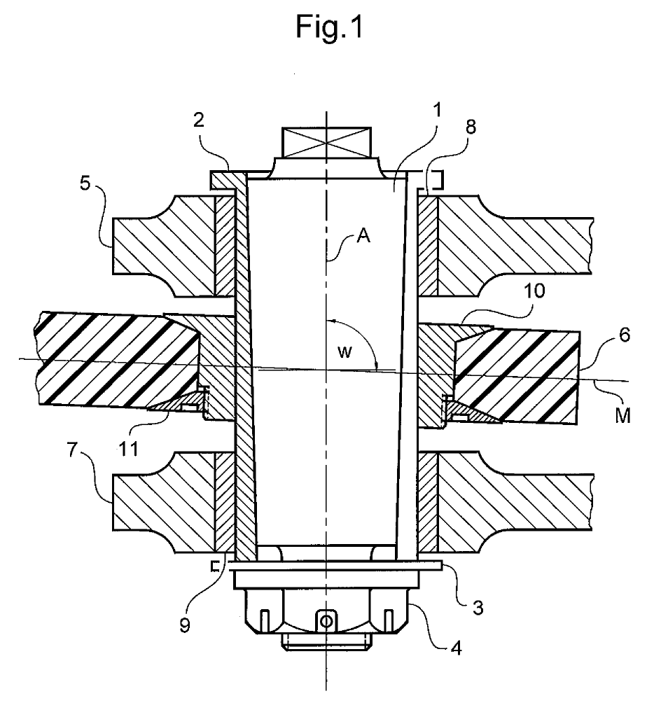

FIG. 1 shows a bolted joint in a sectional representation, comprising a bolt 1, a slotted sleeve 2, a washer 3 and a nut 4. The bolt 1 with the sleeve 2 respectively passes through a structural part 5, a structural part 6 and a structural part 7 and is secured by the washer 3 and the nut 4. The structural parts 5 and 7 are here elements of a fork, not shown, and consist of a metallic material. The bores present in the structural parts 5, 6 and 7 for receiving the sleeve 2 with the bolt 1 respectively form a bolt eye reinforced by a metal bushing 8, 9 and 10. The bushings 8 and 9 consist of suitable material, have a cylindrical shape and are pressed into the particular structural parts 5 and 7. In the illustrated embodiment, the structural part 6 consists of a fibre composite, for which reason there is here provided a screw bushing 10 with a nut 11. The screw bushing 10 is inserted perpendicular to the surface of the structural part 6 of constant thickness. The bore within the bushing 10 for receiving the bolt 1 runs obliquely to the surface of the structural part 6 and at the same angle obliquely to the end face of the bushing 10. The axis A shown in the diagram is thus simultaneously the axis of the bolt 1 and of the said bore. As a result of the shape of the screw bushing 10 with the nut 11, good support is given to the structural part material in the axial direction. The bolt 1 has a conical shape, against which the inner surface of the sleeve 2 comes to bear. For the assembly of the bolted joint, the sleeve 2 is firstly put through the bolt eyes of the structural parts 5, 6 and 7. The bolt 1 is then introduced into the sleeve 2 and secured by means of the washer 3 and the nut 4. Owing to the conical shape of the bolt 1 and the slotted configuration of the sleeve 2, the bolt 1 and the sleeve 2 interact in such a way that the outer diameter of the sleeve 2 enlarges and the outer surface thereof comes firmly to bear against the inner surface of the bushings 8, 9 and 10 when the nut 4 is tightened. The illustrated section is run through the slot of the sleeve 2, so that only that region of the sleeve which can be seen on the left in the diagram appears in hatched representation. In the assembly operation, the nut 4 is tightened with a predetermined torque, whereby a defined radial force is exerted upon the bushings 8, 9 and 10 and thus a non-positive connection is formed for the transfer of loads. The centre plane of the structural part 6 is represented by a line denoted by M. This intersects the axis A of the bolt 1 at an angle W, which, owing to the oblique position of the structural part 6, which is necessary for design reasons, has a defined value ≠90°.

One embodiment of the invention consists in the bolt 1 being cylindrically configured and directly touching the bushings 8, 9 and 10. As a result of the inventive oblique arrangement of the bore for receiving the bolt in the bushing 10, the previous thickening in the region of the particular bolt eye is dispensed with. The aforementioned advantageous effects are thereby achieved, with positive repercussions upon manufacturing costs and weight of the bolted joint.

What is claimed is:

1. A method for autoclave-free adhesive bonding of stringers to an a skin panel in order to form large-sized structural components for aircraft, the method comprising the following steps:
applying at least one adhesive film in the region of connecting points of the stringers and of the skin panel, the adhesive film being a backing fabric impregnated with an epoxy resin;
positioning and aligning the stringers and the skin panel with respect to one another on a supporting structure;
covering the aligned stringers and the aligned skin panel with a vacuum film in order to form a vacuum bag, the vacuum film being applied directly to the stringers and the skin panel which are to be adhesively bonded together;
applying a partial vacuum P_{inside} is applied to the vacuum bag in order to apply a sufficient contact pressure to the stringers and the skin panel by means of the ambient air pressure pₐᵢᵣ₋ₚᵣₑₛₛᵤᵣₑ; and
curing the at least one adhesive film in order to finally adhesively bond the stringers and the skin panel to one another, the curing of the at least one adhesive film taking place at a temperature which is above room temperature.

2. The method according to claim 1, wherein the at least one adhesive film is cured at a partial vacuum between 70 kPa and 100 kPa and at a temperature between 115° C. and 125° C.

3. The method according to claim 1, wherein the surface geometry of the supporting structure corresponds essentially to a surface geometry of the structural component which is to be adhesively bonded together and is composed of the stringers and the skin panel.

4. The method according to claim 1, wherein the stringers and the skin panel are of at least one of an aluminium alloy and a composite material.
